(19) United States
(12) Patent Application Publication
(10) Pub. No.: US 2008/0094278 A1
(43) Pub. Date: Apr. 24, 2008

(54) METHOD AND SYSTEM FOR DISTANCE ESTIMATION

(75) Inventor: Frank J. Castaneda, Raleigh, NC (US)

Correspondence Address: CANTOR COLBURN LLP - IBM RSW, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/551,003

(22) Filed: Oct. 19, 2006

(51) Int. Cl. G01S 5/14

(52) U.S. Cl. 342/357.08; 342/357.17

(57) ABSTRACT

A method of estimating distance with reference to a target location and radius is disclosed. The method includes transforming the target location and radius into a degree offset threshold for avoiding unnecessary distance calculation, receiving a set of global positioning coordinates that define a location of a portable global positioning system (GPS) device, and comparing the set of global positioning coordinates to the degree offset threshold. In response to the set of global positioning coordinates meeting the degree offset threshold, the method further includes calculating a preliminary distance between the global positioning coordinates and the target location.

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to distance estimation, and particularly to global positioning distance estimation.

2. Description of Background

As relates to devices that report their geographic position using GPS, it may be desirable to determine when the device comes within a given distance from a particular location. This is normally done using the Spherical Law of Cosines to solve what is referred to as the Great Circle Difference. Typically, a location notification agent would periodically compute the great circle distance and trigger when it reaches a specified radius from a target location. The drawback is that this calculation may be resource intensive on an embedded processor, as may be used in portable devices. Accordingly, there is a need in the art for a distance estimation arrangement that overcomes these drawbacks.

### SUMMARY OF THE INVENTION

The shortcomings of the prior art are overcome and additional advantages are provided through the provision of a method and system to estimate global position requiring reduced computing resources.

An embodiment of the invention includes a method of estimating distance with reference to a target location and radius. The method includes transforming the target location and radius into a degree offset threshold for avoiding unnecessary distance calculation, receiving a set of global positioning coordinates that define a location of a portable global positioning system (GPS) device, and comparing the set of global positioning coordinates to the degree offset threshold. In response to the set of global positioning coordinates meeting the degree offset threshold, the method further includes calculating a preliminary distance between the global positioning coordinates and the target location.

Another embodiment of the invention includes a method of estimating distance with reference to a target location and radius. The method includes transforming the target location and radius into a degree offset threshold for avoiding unnecessary distance calculation, receiving a set of global positioning coordinates that define a location of a portable global positioning system (GPS) device, and comparing the set of global positioning coordinates to the degree offset threshold. In response to the set of global positioning coordinates meeting the degree offset threshold, calculating a preliminary distance between the global positioning coordinates and the target location via a Pythagorean theorem calculation. Further, in response to the preliminary distance being less than or equal to the radius, providing information related to the target location to the portable GPS device.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which will reduce the computation resources required to estimate the location of a positioning device.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a schematic diagram of a position estimation system in accordance with an embodiment of the invention.

FIG. 2 illustrates one example of a block diagram of a target location and a radius in accordance with an embodiment of the invention.

FIG. 3 illustrates one example of a block diagram of a threshold coordinate requirement in accordance with an embodiment of the invention.

FIG. 4 illustrates one example of a block diagram of a distance estimating calculation in accordance with an embodiment of the invention.

FIG. 5 illustrates one example of a flowchart of an embodiment of a method for estimating distance in accordance with an embodiment of the invention.

The detailed description explains the preferred embodiments of the invention, together with advantages and features, by way of example with reference to the drawings.

### DETAILED DESCRIPTION OF THE INVENTION

An embodiment of the invention, given a set of global positioning coordinates of a target location and a radius, will provide a computation for a maximum degree offset from the location, and use a simpler Pythagorean Theorem calculation to determine when a portable positioning device probably enters a monitored area. A further embodiment will optionally use the Great Circle Difference calculation to determine with increased certainty, as appropriate for the tracking accuracy desired, the position of the portable positioning device.

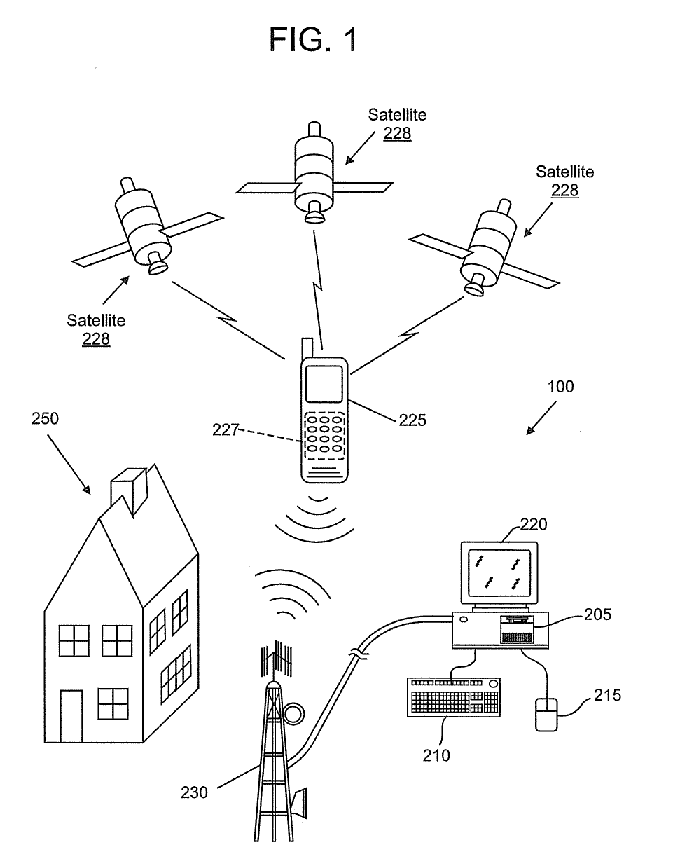

Referring now to FIG. 1, a distance estimation system 100 is depicted. The distance estimation system 100 includes a central computer 200, a portable global positioning system (GPS) device 225, positioning satellites 228, and a cellular radio transmission tower 230. The central computer 200 further includes a program storage device 205, input devices 210, 215, and an output device 220. The portable GPS device 225 includes a processor 227 configured to determine a position of the portable GPS device 225 based upon the reception of signals from the positioning satellites 228, in a manner known in the art as global positioning. In an embodiment, the portable GPS device 225 is a cellular telephone 225.

In an embodiment, it will be desirable to understand if the portable GPS device 225 is within a particular distance from a particular location 250. In an embodiment, the particular location 250 may be a residential location, such as home, for example. In another embodiment, the particular location 250 may be a commercial location, such as a mall, for example. In an embodiment, in response to estimating that the portable GPS device 225 is located within a certain distance from the commercial location, the portable GPS device 225 is configured to notify the computer 200 of the proximity of the portable GPS device 225 to the location 250. In an embodiment, in response to notification of the proximity of the portable GPS device 225 to the location 250, the computer 200 is configured to provide to the portable GPS device 225 content, or information, that is related to the commercial location, such as items that may be offered on sale at the mall, for example.

While embodiments of the invention have been described including a residential location and a commercial location, it will be appreciated that the scope of the invention is not so limited, and that the invention will also apply to distance estimation systems 100 that may include other particular locations, such as workplaces, sporting arenas, and hospitals, for example.

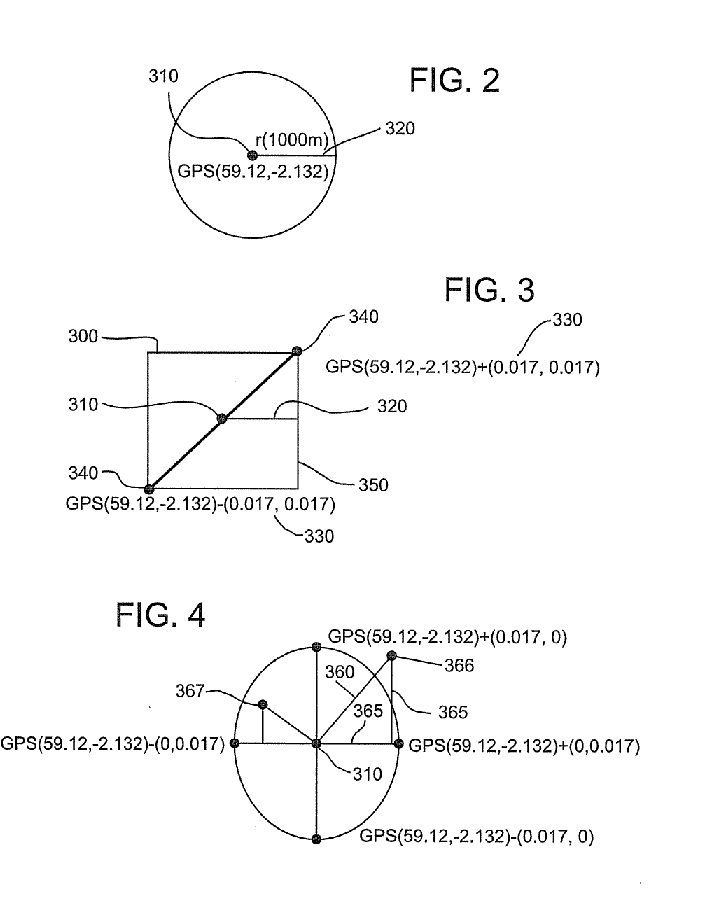

Referring now to FIG. 2, a block diagram of a target location 310 and radius 320 are depicted. In an embodiment, a user will enter, via the computer 200, a set of global positioning coordinates to define the target location 310 in terms of degrees latitude and longitude. The user will also enter the radius 320, or zone of interest surrounding the location 310 so defined. In the example shown in FIG. 2, the target location 310 is depicted to have a latitude and longitude of 59.12 degrees and −2.132 degrees, respectively, and a radius 320 of 1000 meters. In an embodiment, the computer 200 will transfer, via the cellular tower 230, to the portable GPS device 225, the set of global positioning coordinates related to the target location 310. In another embodiment, the portable GPS device 225 will transmit to the computer a set of global positioning coordinates related to the position of the device 225. In an embodiment, at least one of the portable GPS device 225 and the computer 200 is configured to estimate a location of the portable positioning device relative to the target location 310 and the radius 320, or distance from the portable GPS device 225 to the target location 310.

While an embodiment of the invention has been described using a cellular telephone tower 230 to provide signal communication between the portable GPS device 225 and the computer 200, it will be appreciated that the scope of the invention is not so limited, and that the invention will also apply to other distance estimation systems that may use other communication methods, such as a wired or wireless internet connection, Bluetooth, and other radio wave frequencies, for example.

Referring now to FIG. 3, in an embodiment, at least one of the computer 200 and the portable GPS device 225 are configured to perform a computation to transform the target location 310 and the radius 320 into a degree offset threshold 300, also herein referred to as a maximum degree of offset, corresponding to the target location 310 and radius 320. The degree offset threshold 300 will be used as a filtering step to eliminate unnecessary further evaluation, or calculation of portable GPS devices 225 that are obviously outside of the defined radius 320 of the target location 310. The degree offset threshold 300 will transform the location 310 and radius 320 information into a coordinate degree offset 330, related to the target location 310.

The determination of the degree offset threshold 300 shall utilize a rearrangement of the haversine distance formula providing:

$$offset = \frac{meters}{2 * R * \sqrt{{cos}^{2} ( lat ) {sin}^{2} ( \frac{π}{360} )}} \qquad equation \text{-} 1$$

to calculate the degree offset 330, where meters is equivalent to the radius 320 in meters, R is equal to the radius of the earth (6,378,135 meters), and lat is equal to the latitude of the target location 310. It will be appreciated that the example depicted in FIG. 2, wherein the example of the radius 320 is equal to 1000 meters, and the latitude of the target location 310 is 59.12 degrees, the degree offset 330 will be 0.017 degrees.

In an embodiment, at least one of the portable GPS device 225 and the computer 200 is configured to receive a set of global positioning coordinates that define a location of the portable GPS device 225, and to compare the set of global positioning coordinates of the portable GPS device 225 to the degree offset threshold 300. With reference to FIG. 3, it will be appreciated that the combination of the degree offset 330 with the target location 310 will provide a boundary 350 having a square shape that will be over-inclusive. As used herein, the term “over-inclusive” shall indicate a calculation that will include more positions than are actually within the radius 320 of the target location 310, but exclude none of the positions that are within the radius 320 of the target location 310. Accordingly, the boundary 350 provided by the degree offset threshold 300 can be used to determine that the global positioning coordinates of the portable GPS device 225 are probably located within the radius 320 of the target location 310.

The boundary 350 of the degree offset threshold 300 will serve as an initial filter to eliminate further consideration of portable positioning devices 225 that are obviously beyond the radius 320 of the target location 310 by a distance greater than the boundary 350. Accordingly, eliminating further consideration of the distance from the portable GPS device 225 to the target location 310 will reduce the demand for computational resources of the portable GPS device 225. Additionally, because global positioning coordinates are provided in the form of degrees latitude and longitude, the combination of the degree offset 330 with the target location 310 will provide to the portable GPS device 225 a computationally simple comparison to establish if the degree offset threshold 300 has been met. Construction of the degree offset threshold 300 will include addition and subtraction of the degree offset 330 relative to the latitude and longitude coordinates of the target location 310. It will be appreciated that in the example presented, the combination of the degree offset 330 of 0.017 degrees with the target location of (59.12,−2.132) will yield a range, or pair of boundary corners 340 that have coordinates of (59.14,−2.115) and (59.10,−2.149). It will be further appreciated that a simple comparison, or range check can be performed to determine if the set of global positioning coordinates that define the location of the portable GPS device 225 fall within the range of global positioning coordinates that are defined by the corners 340 of the boundary 350.

In an embodiment, prior to evaluating the degree offset threshold 300, at least one of the portable GPS device 225 and the computer 200 are configured to evaluate a rule for larger distances between the portable positioning device and the target location 310. An example of a rule is that if the portable GPS device 225 is located at a latitude greater than a specified upper bound, such as 60 degrees in the present example, it will automatically be determined to be outside of the radius 320 of the target location without any subsequent processing, comparison, or evaluation required. It will be appreciated that, in a similar way, a lower latitude bound can be specified, as well as upper and lower longitude bounds.

Referring now to FIG. 4, in an embodiment, in response to the set of global positioning coordinates of the portable GPS device 225 meeting the degree offset threshold 300, at least one of the computer 200 and the portable GPS device 225 are configured to calculate a preliminary distance from the global positioning coordinates of the portable GPS device 225 to the target location 310. In an embodiment, at least one of the portable GPS device 225 and the computer 200 are configured to calculate the preliminary distance from the global positioning coordinates of the portable GPS device 225 to the target location 310 via a Pythagorean theorem calculation. The Pythagorean theorem preliminary distance calculation will provide increased accuracy as compared to determining if the set of global position coordinates that define the location of the portable GPS device 225 meet the degree offset threshold 300, but will also be over-inclusive. In an embodiment, if it is assumed that the distance between the target location 310 and the portable GPS device 225 is small, and that the ground may be considered to be flat, the differences in degrees of latitude and longitude may be converted into meters. In an embodiment, the Pythagorean theorem calculation will use the equation:

x=\sqrt{a²+b²} equation-2

where x is equal to a hypotenuse 360, and a and b are each equal to a set of legs 365 of a right triangle. In the example above, x is equal to a distance 360, in degrees, from a position 366, represented by a specified pair of coordinates, to the target location 310. The distance 360 is to be compared with the degree offset 330 described above. Further, a and b are the legs 365 of the triangle that are equal to the perpendicular distances, or differences in degrees between the latitude and longitude coordinates of the position 366 and the target location 310.

Continuing with the example provided, it will be appreciated that the position 366 represented by the pair of coordinates such as (59.135, −2.114) will meet the degree offset threshold 300. Calculation of the value of x via equation-2 will yield a value of x of 0.023 degrees, which is greater than the degree offset 330 value of 0.017 degrees, thereby indicating that the preliminary distance calculation between the position 366 and the target location 310 is greater than the radius 320 of the target location 310. Considering another example, a position 367 is represented by the pair of coordinates (59.13, −2.14). Calculation of the value of x for this position via equation-2 will yield a value of x of 0.013 degrees, which is less than the degree offset 330 value of 0.017 degrees, thereby indicating that the preliminary distance between the position 367 and the target location 310 is less than the radius 320 of the target location 310. It will be appreciated that use of equation-2 is a fairly straightforward calculation that does not require intensive computational resources.

In an embodiment, in response to determining that the preliminary distance between a position of the portable GPS device 225 and the target location 310 is less than or equal to the radius 320, at least one of the portable GPS device 225 and the computer 200 are configured to calculate, with greater accuracy, a final distance between the global positioning coordinates of the portable GPS device 225 and the target location 310. In an embodiment, at least one of the portable GPS device 225 and the computer 200 are configured to calculate with greater accuracy the final distance between the subject and the target location via a great circle difference calculation, as provided by equation-3:

$$x = 2 * R * arc sin ( \sqrt{\begin{matrix}{sin}^{2} ( \frac{{lat}_{2} - {lat}_{1}}{2} ) + cos ( {lat}_{1} ) \\ cos ( {lat}_{2} ) {sin}^{2} ( \frac{{lon}_{2} - {lon}_{1}}{2} )\end{matrix}} ) \qquad equation \text{-} 3$$

where the lat₂, lon₂, lat₁, and lon₁ represent the conversion to radians of the coordinates of the two positions to be evaluated, and the trigonometric functions are evaluated in radians. Evaluating the position 367 and the target location 310 for x yields that the final distance between the position 367 and the target location 310 is 1203 meters, demonstrating an example in which the preliminary distance calculation is over inclusive as compared to the more accurate great circle difference final distance calculation in equation-3.

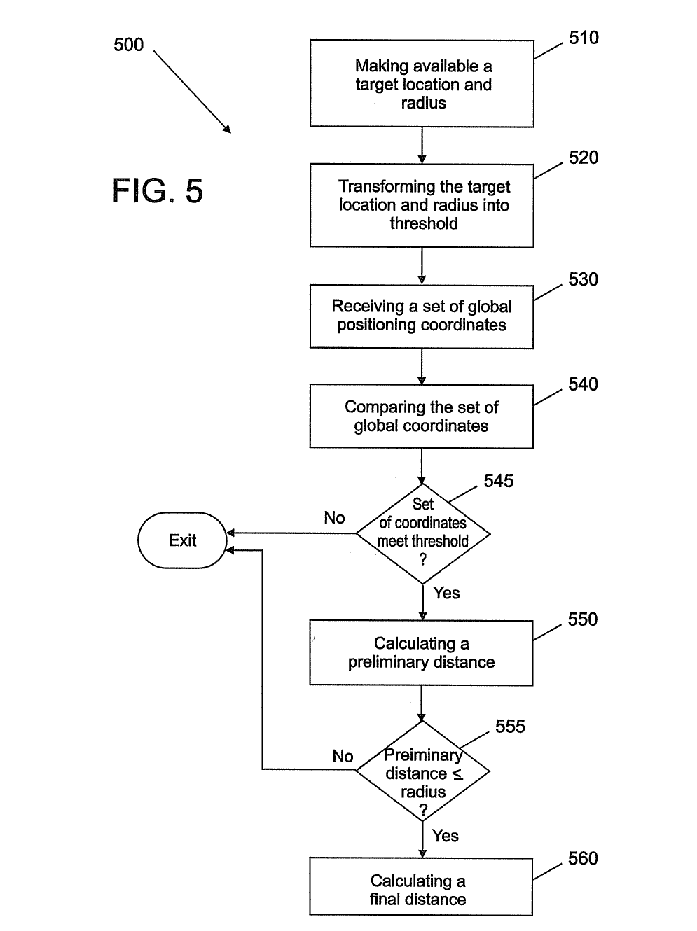

In view of the foregoing, the distance estimation system 100 is configured to perform the method of estimating distance with reference to the target location 310 and radius 320. Referring now to FIG. 5, a flowchart 500 of an embodiment of the method of estimating distance is depicted.

In an embodiment, the method begins with making available 510 the target location 310 and radius 320 and transforming 520 the target location 310 and radius 320 into the degree offset threshold 300 to act as a filter for avoiding unnecessary distance calculations. The method continues with receiving 530 the set of global positioning coordinates that define the location of the portable GPS device 225, and comparing 540 the set of global positioning coordinates to the degree offset threshold 300. It will be appreciated that, in an embodiment, the making available 510 and the transforming 520 need to occur only once, and that the process can subsequently continue by repeatedly receiving 530 updated sets of global positioning coordinates, thereby reducing the need to use the computational resources required to perform the transforming 520 step.

In response to the set of global positioning coordinates meeting the degree offset threshold 300, as determined in decision block 545, the method includes calculating 550 the preliminary distance between the global positioning coordinates of the portable GPS device 225 and the target location 310. It will be appreciated that in response to the set of global positioning coordinates not meeting the degree offset threshold 300, the process will exit, and further calculations, which consume computational resources of the portable GPS device 225, will be avoided.

In an embodiment, the transforming 520 includes transforming the target location 310 and radius 320 into the degree offset threshold 300 via a rearrangement of the haversine distance formula. In an embodiment, the transforming 520 includes transforming the target location 310 and radius 320 into the degree offset threshold 300 to determine when the portable GPS device is probably located within the radius 320 of the target location 310. In an embodiment, in response to the preliminary distance being less than or equal to the radius 320, the method includes providing information related to the target location 310 to the portable GPS device 225.

In an embodiment, the method includes calculating 550 the preliminary distance via the Pythagorean theorem calculation. In an embodiment, in response to the preliminary distance being less than or equal to the radius 320, as determined in the decision block 555, the method further includes calculating 560, with greater accuracy, the final distance between the global positioning coordinates of the portable GPS device 225 and the target location 310. In an embodiment, the calculating 560 the final distance is via the great circle difference calculation. It will be appreciated that in response to the preliminary distance not being less than or equal to the radius 320, the process will exit, and the further calculation of the final distance, which consumes computational resources of the portable GPS device 225, will be avoided.

In an embodiment, any of the comparing 540, the calculating 550 the preliminary distance, and the calculating 560 the final distance are optional steps that are determined and selected by the user depending upon the level of accuracy or conservation of computational resources that are desired.

In an embodiment, in response to the final distance being less than or equal to the radius 320, the method includes providing information related to the target location 310 to the portable GPS device 225.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A method of estimating distance between a portable global positioning device and a target location with reference to a radius from the target location, the method comprising:
entering the target location into the portable global position device in terms of degrees latitude and degrees longitude, the entering performed by a user of the portable global positioning device;
entering the radius into the portable global postioning device, the entering performed by the user of the portable global positioning device;
transforming the target location and radius into a degree offset threshold the transformation utilizing a rearrangement of a haversine distance formula thereby avoiding unnecessary distance calculation;
receiving a set of global positioning coordinates that define a location of the portable global positioning system (GPS) device;
comparing the set of global positioning coordinates to the degree offset threshold; and
in response to the set of global positioning coordinates meeting the degree offset threshold, calculating a preliminary distance between the global positioning coordinates and the target location.

2. (canceled)

3. The method of claim 1, further comprising:
in response to the preliminary distance being less than or equal to the radius, providing information related to the target location to the portable GPS device.

4. (canceled)

5. The method of claim 1, wherein the calculating the preliminary distance comprises:
calculating the preliminary distance via a Pythagorean theorem calculation.

6. The method of claim 1, further comprising:
in response to the preliminary distance being less than or equal to the radius, calculating a final distance, having increased accuracy as compared to the preliminary distance, between the global positioning coordinates and the target location.

7. The method of claim 6, wherein the calculating the final distance comprises:
calculating the final distance via a great circle calculation.

8. The method of claim 6, further comprising:
in response to the final distance being less than or equal to the radius, providing information related to the target location to the portable GPS device.

9. A program storage device readable by a processor, the device embodying a program or instructions executable by the processor to perform the method of claim 1.

10. A method of estimating distance between a portable global positioning device and a target location with reference a radius from the target location, the method comprising;
entering the target location into the portable global position device in terms of degrees latitude and degrees longitude, the entering performed by a user of the portable global positioning device;
entering the radius into the portable global postioning device, the entering performed by the user of the portable global positioning device;
transforming the target location and radius into a degree offset threshold the transformation utilizing a rearrangement of a haversine distance formula for avoiding unnecessary distance calculation;
receiving a set of global positioning coordinates that define a location of the portable global positioning system (GPS) device;
comparing the set of global positioning coordinates to the degree offset threshold;
in response to the set of global positioning coordinates meeting the degree offset threshold, calculating a preliminary distance between the global positioning coordinates and the target location via a Pythagorean theorem calculation; and
in response to the preliminary distance being less than or equal to the radius, providing information related to the target location to the portable GPS device.

11. The method of claim 10, further comprising:
in response to the preliminary distance being less than or equal to the radius, calculating a final distance, having increased accuracy as compared to the preliminary distance, between the global positioning coordinates and the target location via a great circle calculation.

12. A program storage device readable by a processor, the device embodying a program or instructions executable by the processor to perform the method of claim 10.

13. A distance estimation system comprising:
a portable global positioning system (GPS) device; and
means for estimating a location of the portable positioning device relative to a target location and a radius from the target location;
wherein the portable global positioning system includes a means for entry of the target location in terms of degrees latitude and degrees longitude by a user of the portable global positioning system;
wherein the portable global positioning system includes a means for entry of the radius from the target location by the user of the portable global positioning system;
wherein the means for estimating transforms the target location and radius into a degree offset threshold by utilizing a rearrangement of a haversine distance formula for avoiding unnecessary distance calculation; wherein the means for estimating receives a set of global positioning coordinates that define a location of the portable GPS device;
wherein the means for estimating compares the set of global positioning coordinates to the degree offset threshold; and
wherein in response to the set of global positioning coordinates meeting the degree offset threshold, the means for estimating calculates a preliminary distance between the global positioning coordinates and the target location.

14. (canceled)

15. The system of claim 13, wherein:
in response to the preliminary distance being less than or equal to the radius, the means for estimating provides information related to the target location to the portable OPS device.

16. The system of claim 13, wherein:
the means for estimating is configured to calculate the preliminary distance between the global positioning coordinates and the target location via a Pythagorean theorem calculation.

17. The system of claim 13, wherein:
the portable positioning device comprises a cell phone.

18. The system of claim 13, wherein:
in response to the preliminary distance being less than or equal to the radius, the means for estimating calculates a final distance, having increased accuracy as compared to the preliminary distance, between the global positioning coordinates and the target location.

19. The system of claim 18, wherein:
the means for estimating calculates the final distance via a great circle calculation.

20. The system of claim 18, wherein:
in response to the final distance being less than or equal to the radius, the means for estimating provides information related to the target location to the portable GPS device.
